(19) United States
(12) Patent Application Publication
(10) Pub. No.: US 2006/0285452 A1
(43) Pub. Date: Dec. 21, 2006

(54) OPTICAL DISK APPARATUS

(75) Inventor: Hiroshi NAKANE, Kawasaki-City (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Toshiba Samsung Storage Technology Corporation, Kawasaki-city (JP)

(21) Appl. No.: 11/425,236

(22) Filed: Jun. 20, 2006

(30) Foreign Application Priority Data
Jun. 21, 2005 (JP) 2005-180807

(51) Int. Cl. G11B 7/00

(52) U.S. Cl. 369/44.29

(57) ABSTRACT

An optical disk apparatus includes: a focus error signal generation unit which generates a focus error signal for detecting a focal point of a beam spot based on a signal that has been read out from an optical disk through an optical pickup; a focus gain detection unit which detects the loop gain of a focus servo loop based on the focus error signal output from the focus error signal generation unit; and a drive unit which drives a focus actuator for moving the optical pickup in the focusing direction by a drive signal that has been gain adjusted depending on the loop gain detected by the focus gain detection unit.

### CROSS-REFERENCE TO RELATED APPLICATION

This application is based upon and claims the benefit of priority from the Japanese Patent Application No. 2005-180807, filed on Jun. 21, 2005, the entire contents of which are incorporated herein by reference.

### BACKGROUND OF THE INVENTION

1. Field of the Invention

The present invention relates to an optical disk apparatus and, more particularly, to correction for a variation in actuator sensitivity of an optical pickup mounted on the optical disk apparatus.

2. Description of the Related Art

As a method for correcting a variation in actuator sensitivity of an optical disk apparatus, methods disclosed in Jpn. Pat. Appln. Laid-Open Publications Nos. 2002-279654 and 2000-173065 have been known.

In the above methods, distance between the surface of an optical disk and the information recording surface thereof is obtained in terms of time interval while a focus actuator including a focus drive amplifier is driven at a constant slew rate and, based on the obtained distance, the low-frequency sensitivity of the focus actuator is obtained.

In general, there is some variation in the thickness of an optical disk. For example, the thickness of CD is 1.2 mm±0.1 mm and that of DVD is 0.6 mm±0.05 mm. Further, in layer jump of a dual-layer optical disk, so called open control, in which acceleration and deceleration pulses are applied to a focus actuator so as to control the focus actuator, is performed with jump time being set to about 1 msec. Accordingly, the frequency used in the focus actuator becomes about 1 KHz, which corresponds to an inertial damping region (to be described later). However, with the abovementioned method, only sensitivity in a spring dumping region (to be described later) can be obtained. As a result, sensitivity in an inertial dumping region which is controlled by mass, i.e., high-frequency sensitivity cannot be obtained and therefore accurate sensitivity correction cannot be achieved.

Japanese Patent No. 3489780 discloses a technique that differentiates the waveform of a focus error signal to perform speed control during layer jump to thereby reduce influence of the surface blurring of an optical disk and interlayer distance thereon. However, the technique uses amplitude information of a focus error signal, so that if the amplitude of the focus error signal varies, a speed signal is adversely affected with the result that predetermined speed control cannot be achieved.

### SUMMARY OF THE INVENTION

The present invention has been made in view of the problem of a variation in the actuator sensitivity of an optical pickup mounted on a conventional optical disk apparatus, and an object thereof is to provide an optical disk apparatus and a signal processing method of an optical disk apparatus capable of accurately correcting a variation in the sensitivity.

According to an aspect of the present invention, there is provided an optical disk apparatus comprising: a focus error signal generation unit which generates a focus error signal for detecting a focal point of a beam spot based on a signal that has been read out from an optical disk through an optical pickup; a focus gain detection unit which detects the loop gain of a focus servo loop based on the focus error signal output from the focus error signal generation unit; and a drive unit which drives a focus actuator for moving the optical pickup in the focusing direction by a drive signal that has been gain adjusted depending on the loop gain detected by the focus gain detection unit at the time of layer jump.

According to the present invention, an optical disk apparatus capable of accurately correcting a variation in the sensitivity of an actuator of an optical pickup and accurately performing control of layer jump or track jump operation can be obtained.

### BRIEF DESCRIPTION OF THE DRAWINGS

FIG. 1 is a block diagram showing an example of the entire configuration of an optical disk apparatus according to an embodiment of the present invention;

FIG. 2 is a block diagram showing an electrical configuration of an actuator mechanism of an optical pickup;

FIG. 3 is a view showing a configuration of an actuator drive circuit according to the embodiment of the present invention;

FIG. 4 is a block diagram showing a configuration of a focus servo system according to the present invention;

FIGS. 5(a) to 5(c) are views showing focus servo control and tracking servo control according to the embodiment of the present invention;

FIG. 6A is a view showing a circuit configuration of an adder 36a; FIG. 6B is a view showing an example of loop response characteristics of a focus actuator in gain adjustment of a focus servo loop or in layer jump or track jump control; and FIG. 6C is a view showing regions of I/O characteristics of the focus actuator, which corresponds to the gain characteristics shown in FIG. 6B;

FIGS. 7(a) to 7(c) are views showing waveforms of the focus search in the embodiment of the present invention;

FIGS. 8(a) to 8(e) are views showing waveforms in the layer jump operation in the embodiment of the present invention;

FIGS. 9(a) to 9(c) are views showing waveforms in the one-track jump operation;

FIG. 10 is a flowchart showing operation of measuring the actuator sensitivity in the embodiment of the present invention; and

FIG. 11 is a flowchart showing operation of changing the amplitude of the focus error signal of the optical disk apparatus according to the embodiment of the invention.

### DETAILED DESCRIPTION OF THE INVENTION

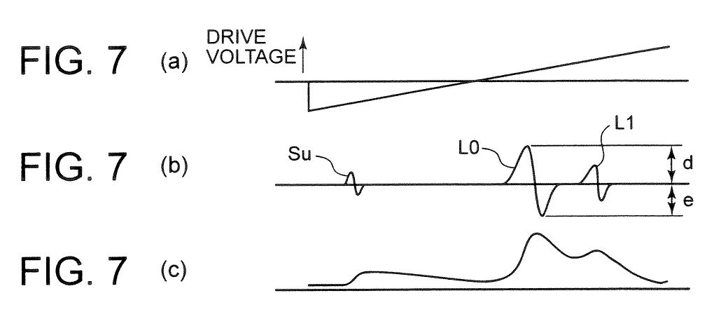

Before proceeding with a detailed description of an embodiment of the invention, some features of the present invention will be described with reference to FIG. 7. FIG. 7 is a view showing a relationship at focus search operation time among the drive voltage of a focus coil, a focus error signal, and a full-added signal obtained as an output from an optical detector. Note that a waveform shown in FIG. 7(b) represents a focus error signal obtained along with the movement of an objective lens in the case where a dual-layer optical disk is used.

In the present invention, response characteristics of a servo loop are examined to measure the actuator sensitivity in an inertial damping region (to be described later), and the actuator sensitivity is corrected based on the sensitivity measured at layer jump time and track jump time.

Further, in the present invention, amplitudes of focus error signals of respective layers on a multiple-layer optical disk are adjusted to the same value. For example, in the case of a dual-layer optical disk, amplitude L0 of a focus error signal on a first layer (layer 0) and amplitude L1 of a focus error signal on a second layer (layer 1) are not always equal to each other due to influence of the reflectance of the signal recording layer, as represented by the waveform of FIG. 7B. There is a variation of about 20 to 30% in the reflectance of an optical disk, in general. At the maximum, a 1.5-fold difference (a variation of 50%) may exist in the reflectance between layers in some optical disks. Note that the layer 0 is closer to an objective lens than the layer 1.

In order to detect the amplitudes L0 and L1 of the focus error signal, it is only necessary to detect peak and bottom values of respective amplitudes. However, the interlayer distance is as small as e.g., 50 μm, so that it is difficult to distinguish between the amplitude L0 and amplitude L1 from peak and bottom values e and d shown in FIG. 7B. In other words, it is impossible to accurately detect a small amplitude like the amplitude L1 of the second layer, as compared to the case of the amplitude L0 of the first layer and, accordingly, it is impossible to determine whether detected values indicate the first or second layer.

According to the present invention, it is possible to estimate a focus error signal from the loop gain of a focus servo loop, so that relative speed control between a beam spot and optical disk surface at the layer jump operation time can be performed accurately and stably. Further, by examining respective servo loop gains of a plurality of layers, a layer having the largest focus error signal can be detected. Further, the amplitudes of focus error signals of respective layers can be adjusted to almost the same value based on the loop gains of respective layers.

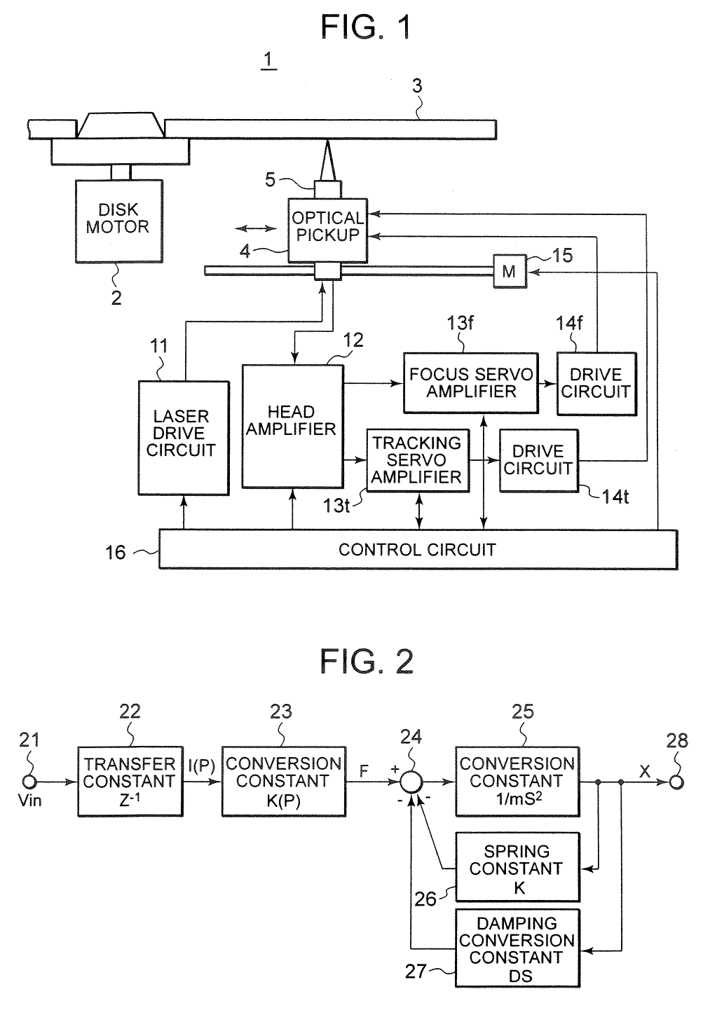

A configuration of the control system of an optical disk apparatus to which the present invention is applied and actuator sensitivity will be described with reference to FIGS. 1, 2, 6C, and 7.

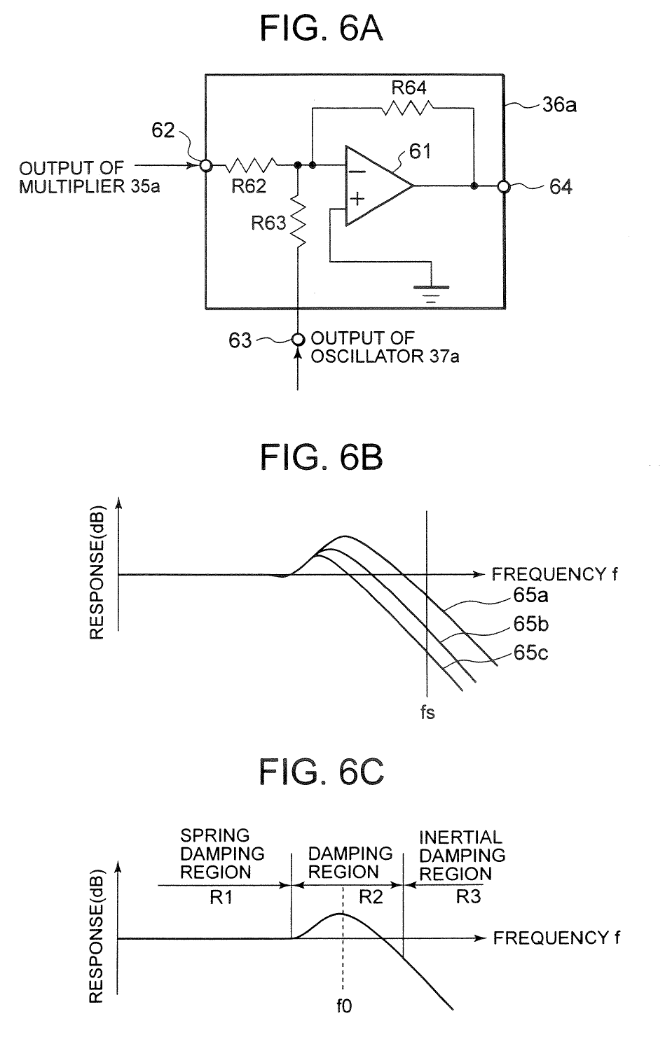

FIG. 1 is a block diagram showing an example of the entire configuration of the optical disk apparatus according to the present embodiment. FIG. 2 is a block diagram showing an electrical configuration of an actuator mechanism of an optical pickup. FIG. 6C is a view showing regions of I/O characteristics of the actuator mechanism of the optical pickup.

Firstly, a configuration of the optical disk apparatus according to the present embodiment will be described with reference to FIG. 1.

In an optical disk apparatus 1, an optical disk 3 is driven and rotated by a disk motor 2. An optical pickup 4 irradiates one recording layer of the optical disk 3 with a laser beam through an objective lens 5 and reads out information recorded in the optical disk 3 from a reflected light of the laser beam.

The control system of the optical disk apparatus 1 includes a laser drive circuit 11, a head amplifier 12, a focus servo amplifier 13f, a drive circuit 14f, a tracking servo amplifier 13t, a drive circuit 14t, a feed motor 15, a control circuit 16, and the like.

The laser drive circuit 11 drives the optical pickup 4 according to a signal from the control circuit 16 and allows the optical pickup 4 to irradiate the optical disk 3 with a laser beam through the objective lens 5. The head amplifier 12 amplifies the reflected light that the optical pickup 4 has received from the optical disk 3 and generates a focus error signal, tracking error signal, and the like so as to output them. The focus servo amplifier 13f amplifies the focus error signal output from the head amplifier 12 and performs phase compensation for the amplified focus error signal. The first drive circuit 14f uses an output of the focus servo amplifier 13f to generate a focus drive signal for driving a focus actuator of the optical pickup 4. The tracking servo amplifier 13t amplifies the tracking error signal output from the head amplifier 12 and performs phase compensation for the amplified tracking error signal. The second drive circuit 14t uses an output of the tracking servo amplifier 13t to drive a tracking actuator of the optical pickup 4. The feed motor 15 feeds the optical pickup 4 in the radial direction of the optical disk 3. The control circuit 16 controls the laser drive circuit 11, head amplifier 12, focus servo amplifier 13f, tracking servo amplifier 13t, first and second drive circuits 14f, 14t, feed motor 15, and the like.

The optical disk 3 can be rotated by the disk motor 2. The optical pickup 4 is moved by the feed motor 15 in the radial direction of the optical disk 3. The optical pickup 4 incorporates a laser diode. The laser diode (not shown) is drive-controlled by the laser drive circuit 11 and emits a predetermine amount of laser beam toward the optical disk 3.

A laser beam emitted from the laser diode passes through optical elements in the optical pickup 4 and is emitted from the objective lens 5. The laser beam is focused by the objective lens 5 onto the signal recording layer (layer 0 or layer 1) of the optical disk 3 and then reflected. The laser beam reflected by the signal recording layer of the optical disk 3 passes through the objective lens 5 and optical elements of the optical pickup 4 and enters a photodetector divided into e.g., four parts.

A signal output from the photodetector of the optical pickup 4 is amplified by the head amplifier 12 as described later and, after that, subjected to arithmetic processing to be converted into a focus error signal and tracking error signal. The focus error signal drives the objective lens 5 in the focusing direction through the focus servo amplifier 13f and first driving circuit 14f. The tracking error signal drives the objective lens 5 in the tracking direction through the tracking servo amplifier 13t and second drive circuit 14t. Control of the respective components of the optical disk apparatus 1 is performed by the control circuit 16. Although various actuators can be used for moving the objective lens 5, a two-axis moving coil actuator is used in the present embodiment.

The two-axis moving coil actuator generally includes a moving coil for focusing control and a moving coil for tracking control (which are collectively referred to as actuator coil, hereinafter) for moving the objective lens 5 in the focusing and tracking directions and a lens holder with which the objective lens 5 is integrated. The lens holder is attached to the main body of the optical pickup 4 by means of a plurality of suspension wires having spring characteristics through a damping material so as to be movable in the focusing and tracking directions.

A magnet that constitutes a magnetic circuit together with the actuator coil is attached to the main body of the optical pickup 4. More specifically, the magnet is so attached to the optical pickup 4 through an air gap (magnetic gap) as to face the actuator coil. When current is applied to the actuator coil, a magnetic force acts between the magnet and actuator coil to move the objective lens 5 in the focusing and tracking directions.

FIG. 2 is a block diagram showing an electrical configuration of the actuator mechanism of the optical pickup having the above configuration. Although the diagram is represented with a voltage drive, the back voltage in the coil is so small that it is omitted.

A drive voltage Vin is applied to an input terminal 21. Then, the drive voltage Vin is converted into current by a transfer constant: 1/Z(Z⁻¹) in a block 22 and is output as a drive current I (P). The drive current I (P) is converted into a drive output F in a block 23 by a conversion constant K(P) which is a value proportional to the winding number of the actuator coil and magnitude of the magnet and is output from the block 23. The drive output F is then input to a block 25 and is converted into a variation X by a conversion constant: 1/mS² in the block 25 which concerns a mass m of the movable portion and is output outside. The variation X is also negatively fed back to an input point 24 of the block 25 through a block 26 having a spring constant K and a block 27 having a damping conversion constant DS.

The mass m of the movable portion in the block 25 indicates mainly the mass of the lens holder of the objective lens 5, and S indicates the Laplace operator. The spring constant K of the block 26 is a constant proportional to the spring constant K of the suspension wire. The damping constant DS in the block 27 is the damping constant of the damping material provided in the suspension system of the lens holder.

As shown in FIG. 6C, the I/O characteristics of the actuator mechanism are roughly divided into three regions: a spring damping region R1 in which the characteristics are substantially determined by the spring constant K; a damping region R2 including a resonance frequency f0 and in which the characteristics are substantially determined by the spring constant K and movable mass m; and an inertial dumping region R3 in which the characteristics are substantially determined by the movable mass m. The response of the resonance frequency f0 is generally set to about 50 to 60 Hz both in the focusing and tracking systems. Note that the response of the resonance frequency f0 depends on the damping constant DS in the block 27.

In such a moving coil actuator mechanism, a variation in transfer characteristics is generated due to the mechanical dimension and material of the spring member of the suspension wire, resistance of the actuator coil, magnetic force of the magnet, magnetic gap, and the like in the spring damping region R1. Further, in the inertial damping region R2, a variation in transfer characteristics is generated due to the movable mass m, coil impedance, magnetic force of the magnet, magnetic gap, and the like.

The spring damping region R1 of the actuator mechanism is generally used in focus search operation, determination of a disk type, measurement of a focus error amplitude, and the like. The present invention is featured in that the inertial damping region R2 is used in adjustment of a servo loop gain, layer jump operation, and track jump operation.

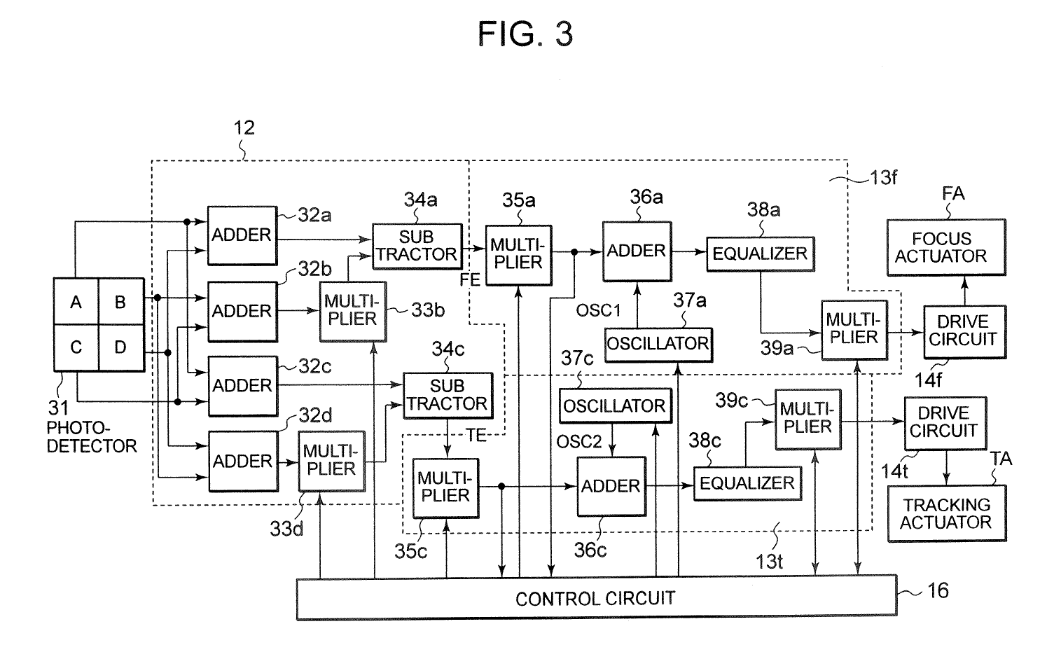

Next, a concrete embodiment of the present invention will be described with reference to FIGS. 3 to 9. FIG. 3 is a configuration of an actuator drive circuit according to the embodiment of the present invention.

Note that, in this embodiment, the actuator drive circuit uses a 4-divided photodetector 31 constituted by four photodetector elements A, B, C, and D, uses astigmatism method for detection of a focus error signal, and uses a push-pull method for detection of a tracking error signal.

The head amplifier 12 of the actuator drive circuit includes: adders 32a (A+D), 32b (B+C), 32c (A+C), 32d (B+D) to which two detection signals are input respectively from the 4-divided photodetector 31; a multiplier 33b connected to the output of the adder 32b; a multiplier 33d connected to the output of the adder 32d; a subtractor 34a connected to the outputs of the adder 32a and multiplier 33b; and a subtractor 34c connected to the outputs of the adder 32c and multiplier 33d.

The focus servo amplifier 13f includes: a multiplier 35a connected to the output of the subtractor 34a; an adder 36a connected to the outputs of the multiplier 35a and oscillator 37a; an equalizer 38a connected to the output of the adder 36a and having an integral compensation function or differential compensation function; and a multiplier 39a connected to the equalizer 38a.

Similarly, the tracking servo amplifier 13t includes: a multiplier 35c connected to the output of the subtractor 34c; adder 36c connected to the outputs of the multiplier 35c and oscillator 37c; an equalizer 38c connected to the output of the adder 36c and having an integral compensation function or differential compensation function; and a multiplier 39c connected to the equalizer 38c.

The first drive circuit 14f receives the output of the multiplier 39a and drives a focus actuator FA. The second drive circuit 14t receives the output of the multiplier 39c and drives a tracking actuator TA. The control circuit 16 controls the above multipliers 33b, 33d, 35a, 35c, 39a, 39c, and oscillators 37a, 37c. Note that the multipliers 33b, 33d, 35a, 35c, 39a, 39c serve as a variable gain amplifier.

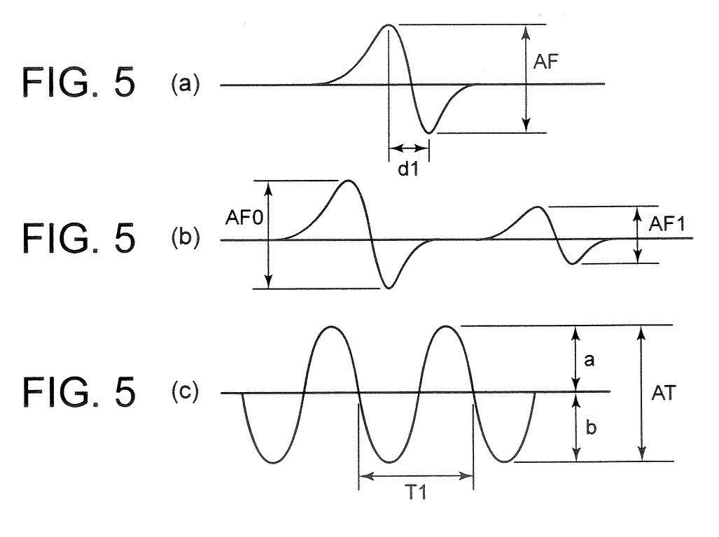

The multiplier 35a has a function of optimally adjust a focal point and is controlled by the control circuit 16 such that the total sum of the signals received by the four photodetector elements A, B, C, D of the 4-divided photodetector 31 becomes maximum, i.e., a laser light spot is completely focused onto a target signal recording area on the optical disk 3. Although it is necessary to provide a direct current offset adjuster that cancels a direct current offset generated in the above circuits, it is omitted in FIG. 3. The multiplier 35c has a function of adjusting a tracking point. When detecting a tracking error signal, the control circuit 16 controls the multiplier 35c such that the positive and negative amplitudes a and b of the tracking error signal shown in the waveform of FIG. 5(c) becomes equal to each other.

The waveform shown in FIG. 5(a) is a focus error signal in the case where a single-layer optical disk is used. The waveform shown in FIG. 5(b) is a focus error signal in the first layer (layer 0) and second layer (layer 1) in the case where a dual-layer optical disk is used. The waveform shown in FIG. 5(c) is a tracking error signal.

The amplitude AF of FIG. 5(a) is an amplitude of a focus error signal obtained in the case where a single-layer optical disk is used. The amplitude AF0 of FIG. 5(b) is an amplitude of a focus error signal in the first layer (layer 0) of dual-layer optical disk, and the amplitude AF1 of FIG. 5(b) is an amplitude of a focus error signal in the second layer (layer 1) of dual-layer optical disk. The amplitude AT of FIG. 5(c) is an amplitude of a tracking error signal, and the amplitudes a and b represent the amplitudes of a tracking error signal in the positive and negative directions, respectively.

The initial values of the multipliers 35a and 35c shown in FIG. 3 are set to 0 dB. This initial value “0 dB” is a target value of optical adjustment in the optical pickup 4. The subtractor 34a outputs a focus error signal FE and subtractor 34c outputs a tracking error signal TE. An optical adjustment error in the optical pickup 4 can be removed by increasing and decreasing the amplification degrees of the multipliers 35a and 35c having a variable amplification function under the control of the control circuit 16.

The subtractor 34a subtracts the output of the multiplier 33b from the output of the adder 32a that adds signals from the photodetector elements A and D. The input of the multiplier 33b is the output of the adder 32b that adds signals from the photodetector elements B and C. Accordingly, assuming that the light amount to be input to the 4-divided photodetector 31 is P, the focus error signal FE which is an output signal of the subtractor 34a can be represented as follows: FE=((A+D)−(B+C))P, where light amount P is a value proportional to the intensity of a laser output beam and the reflectance of the optical disk 3.

The subtractor 34c subtracts the output of the multiplier 33d from the output of the adder 32c that adds signals from the photodetector elements A and C. The input of the multiplier 33d is the output of the adder 32d that adds signals from the photodetector elements D and B. Accordingly, the tracking error signal TE which is an output signal of the subtractor 34c can be represented as follows: TE=((A+C)−(B+D))P.

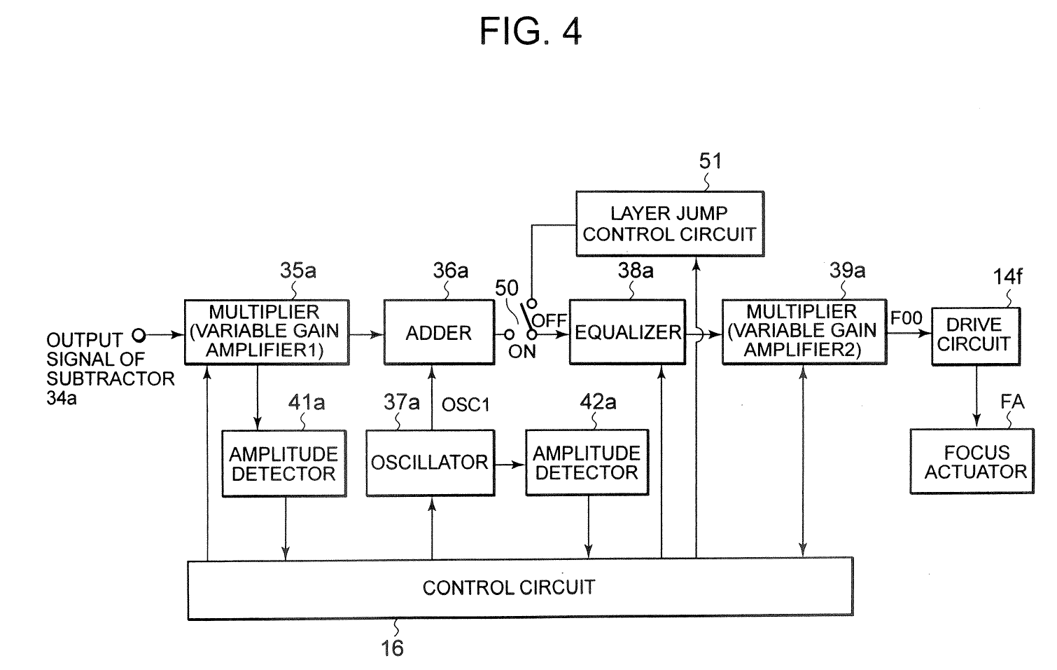

FIG. 4 is a view showing a configuration of a focus servo system 13f in the actuator drive circuit shown in FIG. 3. In FIG. 4, a switch 50 is an electrical switch whose ON/OFF is controlled by the control circuit 16 to thereby turn focus servo operation ON and OFF. A layer jump control circuit 51 receives a layer jump request from the control circuit 16 during the layer jump execution time and outputs a voltage for moving the focus of the objective lens 5 to a target layer. Further, the layer jump control circuit 51 monitors a focus error signal and, when detecting that the focus of the objective lens 5 has approached the target layer, outputs a voltage for stopping the movement of the objective lens 5. The same reference numerals denote the same or corresponding parts as in FIG. 3, and the descriptions thereof will be omitted. Although amplitude detectors 41a and 42a are provided outside the control circuit 16 in FIG. 4, they may be incorporated in the control circuit 16. A signal generated from the drive circuits 14f and 14t is not limited to a voltage signal, but may be a current signal. The layer jump control circuit 51 may be incorporated in the control circuit 16.

In order to reproduce data recorded on the signal recording layer of the optical disk 3, a laser beam collected by the objective lens 5 of the optical pickup 4 needs to be focused on the signal recording layer of the optical disk 3. In the optical disk apparatus, focus search that moves the objective lens 5 in the optical axis direction (focusing direction) is performed in order to set the objective lens 5 to a position at which a laser beam is focused on the signal recording layer. To realize this, a not shown focus search control circuit is provided.

In the focus search operation, the gain of the multiplier 35a is set to an initial value of “0 dB”. The focus error signal FE from the subtractor 34a is input to the multiplier 35a, and the amplitude of the focus error signal FE is detected in the amplitude detector 41a. Then, the control circuit 16 controls a not shown focus search circuit to perform focus search operation in accordance with a value of the amplitude detected in the amplitude detector 41a.

The focus search operation will next be described with reference to FIGS. 7(a) to 7(c). FIG. 7 shows a relationship between a drive voltage applied to a focus coil during the focus search operation (FIG. 7(a)), a focus error signal (FIG. 7(b)) and a signal obtained as an output from the photodetector (FIG. 7(c)). The positive direction (the direction denoted by the arrow) of the drive voltage applied to a focus coil shown in FIG. 7(a) is a direction in which the objective lens 5 approaches the optical disk 3.

Amplitudes L0 and L1 of the focus error signal shown in FIG. 7(b) represent focus error signals FE obtained along with the movement of the objective lens 5 in the case where a dual-layer optical disk 3 is used. FIG. 7(c) represents a total-reflected optical signal obtained from the dual-layer optical disk 3, which corresponds to a full-added signal of signals output from the respective photodetector elements A, B, C, and D. The horizontal axis of FIGS. 7(a) to 7(c) is time.

When a drive voltage for focus search is switched from negative direction to positive direction as shown in FIG. 7(a), a focus error signal FE, as represented by a signal Su of FIG. 7(b), reflected from the surface of the optical disk 3 is firstly obtained. Then, a focus error signal FE, as represented by the amplitude L0, reflected from the first layer (layer 0) near the surface of the optical disk 3 is obtained. Finally, a focus error signal FE, as represented by the amplitude L1, reflected from the second layer (layer 1) of the optical disk 3 is obtained. In FIG. 7(b), peak and bottom values d and e are obtained from a laser beam reflected from the first layer (layer 0).

When the focus error signal FE shown in FIG. 7(b) is output from the multiplier 35a by the focus search operation, the amplitude detector 41a shown in FIG. 4 detects the maximum amplitudes of the signal Su, amplitude L0, and amplitude L1. Then, the gain of the multiplier 35a is set by the control circuit 16 such that the maximum amplitude among the detected amplitude values (i.e., amplitude L0 of the layer 0) becomes a target value. As is clear from FIG. 7(b) and FIG. 5(b), the amplitude AF0 of the focus error signal FE can be measured simply by detecting its peak and bottom values d and e.

After the gain of the amplitude AF0 of the focus error signal FE has been set in the multiplier 35a, the control circuit 16 performs the focus search operation once again. When focusing is achieved, the control circuit 16 stops the focus search operation and turns ON the switch 50 to form a circuit configuration so as to allow a focus servo system to operate.

The gain adjustment of a focus servo loop will next be described. The gain of the focus servo loop is controlled by adding an output signal OSC1 of the oscillator 37a controlled by the control circuit 16 to the adder 36a as a disturbance signal.

FIG. 6A shows a concrete circuit configuration of the adder 36a. The adder 36a includes: an operating amplifier 61 whose positive input terminal is grounded; a resistor R62 connected between the negative input terminal of the operating amplifier 61 and an input terminal 62 of the adder 36a; a resistor R63 connected between the negative input terminal of the operating amplifier 61 and an oscillator input terminal 63 of the adder 36a; and a resistor R64 connected between an output terminal 64 of the operating amplifier 61 and the negative input terminal thereof. The adder 36c has the same configuration as that of the adder 36a, and its description is omitted.

The same value is applied to the resistors R62, R63, and R64, and the gain of the adder 36a is set to “1”. In this state, the control circuit 16 calculates a ratio between the amplitude of the disturbance input signal OSC1 to be input from the oscillator 37a to the adder 36a and the amplitude of a signal input from the multiplier 35a to the adder 36a to thereby obtain the loop gain of the focus servo loop. In other words, by calculating a ratio between an output of the amplitude detector 41a that detects the amplitude of the multiplier 35a and an output of the amplitude detector 42a that detects the amplitude of the oscillator 37a outputting the OSC1, it is possible to obtain the loop gain of the focus servo system.

Similarly, the control circuit 16 calculates a ratio between the amplitude of the disturbance input signal OSC2 to be input from the oscillator 37c to the adder 36c and the amplitude of a signal input from the multiplier 35c to the adder 36c to thereby obtain the loop gain of the tracking servo loop. Although the same resistance value is applied to the resistors R62, R63, and R64 in the above description, it goes without saying that the loop gain can be obtained even when they have different resistance values.

FIG. 6B shows an example of loop response characteristics of the focus actuator FA in the gain adjustment of the focus servo loop or in the layer jump or track jump control. The loop response characteristic represents the frequency response characteristics of an output signal of the multiplier 35a relative to the output signal OSC1 of the oscillator 37a. That is, each characteristic curve in FIG. 6B is obtained by dividing an output value of the amplitude detector 41a by an output value of the amplitude detector 42a.

FIG. 6C shows the operation region of the focus actuator FA, which corresponds to the gain characteristics shown in FIG. 6B. The resonance frequency f0 shown in FIG. 6C substantially corresponds to the cut-off frequency of the focus servo loop. Therefore, the disturbance signal frequency fs (see FIG. 6B) used for the gain adjustment of the focus servo loop or the layer jump or track jump control higher than the resonance frequency f0 is selected. In general, a frequency of about 1.5 to 2.5 kHz is selected as the disturbance signal frequency fs. As is clear from FIGS. 6B and 6C, the gain adjustment of the focus actuator FA according to the present invention is executed in the inertial damping region R3.

In FIG. 6B, a loop response characteristic curve 65a denotes a case where the loop gain is higher than a target value “1”. A loop response characteristic curve 65b denotes a case where the loop gain is same as the target value “1”. A loop response characteristic curve 65c denotes a case where the loop gain is lower than the target value “1”. The above loop gain values are obtained by the control circuit 16.

The input signal of the adder 36a is a frequency component of the focus error signal FE. The input signal of the adder 36c is a frequency component of the tracking error signal TE. Therefore, in order to obtain the same frequency components as those of the oscillators 37a and 37c, the control circuit 16 uses a band-pass filter, in general. Besides, there is a method of obtaining the loop gain of the focus servo loop from a phase difference between the output signal OSC1 of the oscillator 37a and input signal of the adder 36a. Further, the loop gain can be obtained from a phase difference between the output signal OSC2 of the oscillator 37c and input signal of the adder 36c.

In the gain adjustment of the focus actuator FA in the adjustment of the loop gain of the focus servo loop or layer jump or tracking jump control, if the loop response characteristic curve 65a shown in FIG. 6B as the sensitivity of the focus actuator FA is obtained, the control circuit 16 subtracts the value (i.e., target value) of the loop response characteristic curve 65b from the value of the loop response characteristic curve 65a to reduce the gain of the multiplier 39a by the gain corresponding to (65a−65b). Alternatively, the control circuit 16 performs loop control while reducing the gain of the multiplier 39a in a stepwise fashion until the absolute value of (65a−65b) falls within a predetermined range. If the loop response characteristic curve 65c shown in FIG. 6B is obtained as the sensitivity of the focus actuator FA, the control circuit 16 subtracts the value of the loop response characteristic curve 65c from the value (i.e., target value) of the loop response characteristic curve 65b to increase the gain of the multiplier 39a by the gain corresponding to (65b−65c).

With the above processing, it is possible to adjust the frequency response characteristics while making the high-frequency sensitivity of the input of the multiplier 39a, drive circuit 14f, and focus actuator FA constant. Therefore, the control circuit 16, which controls that series of control operations, becomes to know the adjusted high-frequency sensitivity of the focus actuator FA because it can know the amplitude and loop gain of the focus error signal.

Further, the gain adjustment of the tracking servo loop in the multiplier 39c can also be performed in the same manner as the abovementioned gain adjustment of the focus servo loop. The control circuit 16 allows the multiplier 39c to adjust the balance of the tracking error signal such that the absolute values of the positive and negative amplitudes a and b of the tracking error signal shown in FIG. 5C become equal to each other.

The layer jump operation to which the above gain adjustment is applied will next be described. Upon receiving an instruction of the layer jump during reproduction of the optical disk 3, the control circuit 16 turns OFF the switch 50 of the focus servo. Then, the control circuit 16 sends a layer jump command to the layer jump control circuit 51.

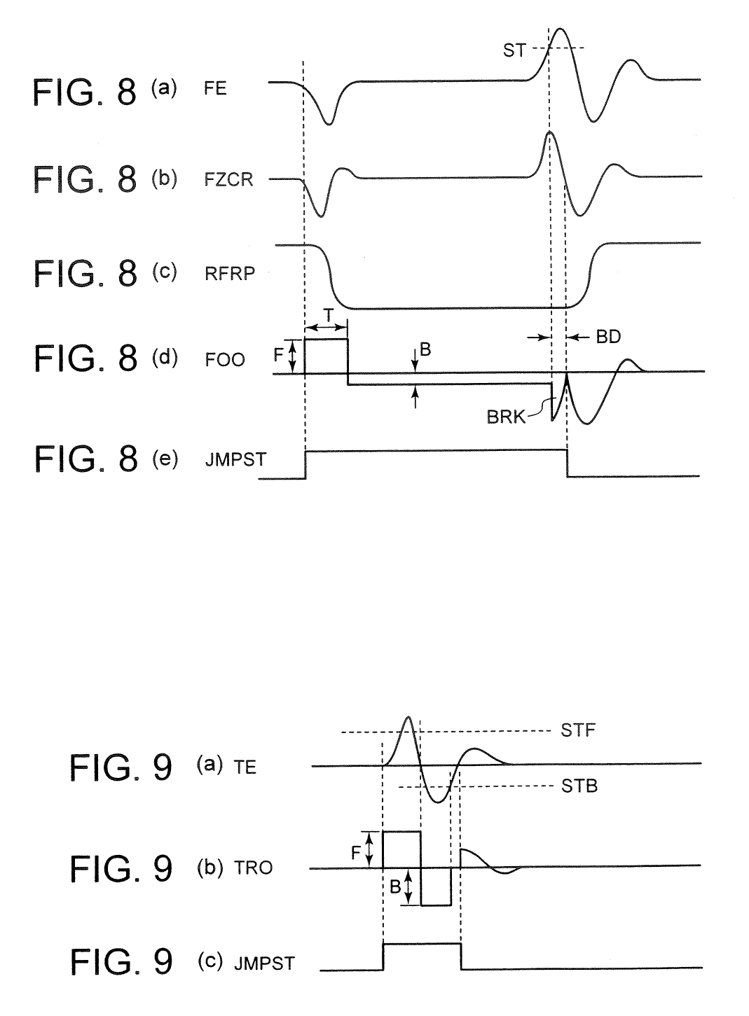

FIGS. 8(a) to (e) show a relationship between respective waveforms in the layer jump operation. FIG. 8(a) shows a waveform of the focus error signal (FE), FIG. 8(b) shows a waveform (speed component) of the differential signal (FZCR) of the focus error signal FE. A value obtained by dividing the amplitude of the FZCR signal by the amplitude of the focus error signal FE (FZCR/FE) is a differential gain. That is, a drive signal FOO generated based on the differential gain allows the focus actuator FA to be driven by a target gain value.

FIG. 8(c) shows a waveform of a high-frequency amplitude signal (RFRP), FIG. 8(d) shows a waveform of the actuator drive signal (FOO) output from the multiplier 39a, and FIG. 8(e) shows a waveform of a focus servo ON/OFF signal for the switch 50.

Upon receiving an instruction of the layer jump, the control circuit 16 sets a JMPST signal shown in FIG. 8(e) to high “H”, turns OFF the switch 50, and connects to the layer jump control circuit 51. Then, as shown in FIG. 8(d), in response to an output of the layer jump control circuit 51, the drive circuit 14f outputs an actuator drive pulse having an amplitude F for accelerating the FOO signal in a predetermined direction for time period T to the coil of the focus actuator FA. Then, after the time period T has elapsed, the drive circuit 14f outputs a break drive pulse having an amplitude B to the coil of the focus actuator FA until the focus error signal FE reaches a level ST.

Then, the drive circuit 14f outputs a BRK signal which has an opposite polarity to that of the FZCR signal for time period BD to the coil of the focus actuator FA. This means the speed of the focus servo is controlled by the BRK signal created depending on the sensitivity of the focus actuator FA. The time period BD shown in FIG. 8(d) ends at the time point at which the FZCR signal reaches the zero-cross point. Upon detecting the zero-cross point, the control circuit 16 sets the JMPST signal to low “L”, turns ON the switch 50, and connects to the focus servo. Note that, in the case of the tracking servo, the control circuit 16 turns OFF the switch 50 before the JMPST signal reaches high “H” and turns ON the switch 50 after the JMPST signal has reached high “H”.

At this time, if the high-frequency sensitivity of the focus actuator FA is not added to the width T of the actuator drive pulse of the FOO signal and amplitude B of the brake drive pulse shown in FIG. 8(d), accuracy of the jump speed of a laser spot deteriorates. However, in the present invention, the FOO signal obtained by differentiating and inverting the FZCR signal which is the high-frequency sensitivity of the focus actuator FA is output to the multiplier 39a. Accordingly, an output that has been gain adjusted to a target value is supplied to the drive circuit 14f by the multiplier 39a, so that drive of the optical pickup 5 is accurately carried out by the focus actuator FA.

The speed signal represented by the BRK signal depends on the amplitude of the focus error signal FE, and speed control is performed based on an error between the BRK signal and a speed target value. Therefore, a change in the focus error signal FE corresponds to a change of the speed target value of the speed control. When the amplitude of the focus error signal FE is displaced from a predetermined value, stable speed control cannot be achieved.

The loop gain of the focus error signal FE depends on the high-frequency sensitivity of the focus actuator FA, so that when the high-frequency sensitivity is stabilized, stable speed control can be achieved. Further, it is possible to substantially correct a variation in the relative moving speed between a beam spot and optical disk surface at the layer jump operation time by correcting the high-frequency sensitivity.

Note that the detection distance d1 of the focus error shown in FIG. 5(a) is determined by optical elements used in the optical pickup 4.

The track jump operation to which the above gain adjustment is applied will next be described. FIGS. 9(a) to 9(c) show a relationship between respective waveforms in the track jump operation. FIG. 9(a) shows a tracking error signal TE. The level STB of the tracking error signal TE represents a stand-by level used at the time when a beam spot is jumped in the forward direction (direction from the inner circumferential side to outer circumferential side) of the optical disk 3. The level STF represents a stand-by level used at the time when a beam spot is jumped in the backward direction (direction from the outer circumferential side to inner circumferential side) of the optical disk. FIG. 9(b) shows a waveform of a drive signal TRO of the tracking actuator, which is a acceleration pulse. FIG. 9(c) shows a waveform of a jump-time signal JMPST. The following adjustment control of the tracking servo is performed by the control circuit 16.

Upon receiving an instruction of the track jump, the control circuit 16 sets the JMPST signal shown in FIG. 9(c) to high “H”, disconnects the tracking servo, and connects to a not shown tracking jump control circuit. Then, in response to an output of the tracking jump control circuit, the control circuit 16 outputs the drive signal TRO shown in FIG. 9(b) and having an amplitude F in a predetermined direction to the coil of the tracking actuator TA until the tracking error signal TE reaches the zero-cross point. Then, the drive circuit 14t outputs a deceleration pulse having an amplitude B to the coil of the tracking actuator TA until the tracking error signal TE exceeds the level STB. At the time when the tracking error signal TE reaches the zero-cross point, the control circuit 16 sets the JMPST signal to low “L”, disconnects the tracking jump control circuit, connects to the tracking servo, and ends the one-track jump.

At this time, acceleration state is determined by a product of the amplitude F of the drive signal TRO and the high-frequency sensitivity of the tracking actuator TA, so that stability of jump time is determined. That is, as in the case of the layer jump operation time, it is possible to substantially correct a variation in the relative moving speed between a beam spot and optical disk surface at the track jump operation time, which is generated due to a variation of the high-frequency sensitivity, by correcting the high-frequency sensitivity.

Incidentally, when the sensitivity of the tracking actuator TA is increased to excess, acceleration/deceleration speed of the track jump becomes too high and stability becomes worse. In contrast, when the sensitivity of the tracking actuator TA is decreased to excess, stability becomes worse especially when the eccentricity of the optical disk is large. This tendency becomes prominent as the number of track jumps in one time is increased.

A zero-cross time T1 of the tracking error signal TE shown in FIG. 5C is a distance between tracks determined by a track pitch. Assuming that the amplitude AT is made constant, the gain of the tracking loop is increased as the time T1 is reduced. Note that a configuration diagram of the track jump control section is omitted here.

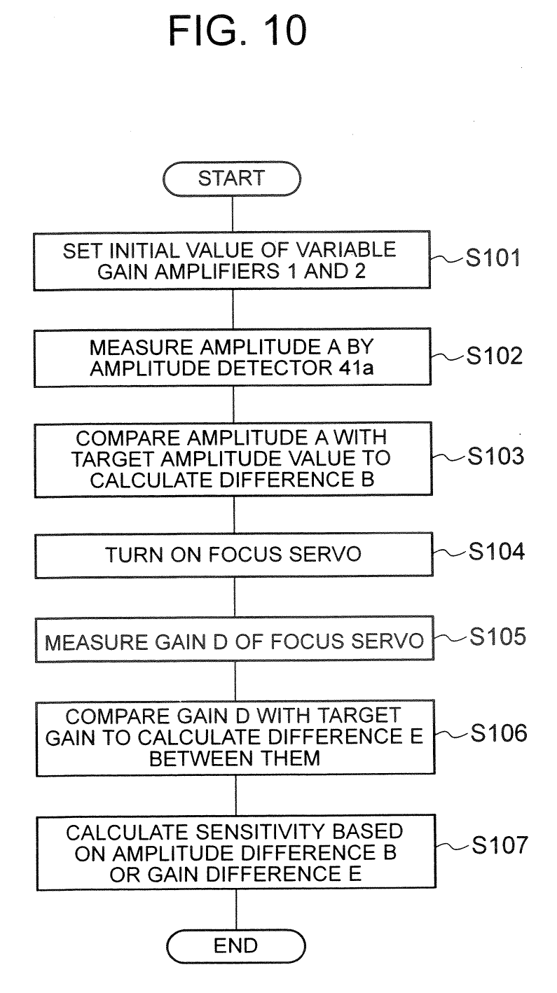

Measurement of the sensitivity of focus actuator FA or tracking actuator TA, which is an important factor in the control of the abovementioned gain adjustment, will next be described. As a concrete example, a method for measuring the sensitivity of the focus actuator performed by the control circuit 16 will be described with reference to a flowchart shown in FIG. 10. FIG. 10 shows a flowchart for measuring the sensitivity of the focus actuator using the configuration shown in FIG. 4. The abovementioned gain adjustment in the layer jump or track jump operation is executed based on a result of the sensitivity measurement described here.

The control circuit 16 turns OFF the switch 50 of the focus servo and sets the initial value of the gain previously set in the variable gain amplifiers 1 and 2 (multipliers 35a and 39a of FIG. 4) (step S101). At this time, the gain of the variable gain amplifier 1 (multiplier 35a of FIG. 4) is set such that the amplitude of the focus error signal FE becomes a target value depending on the type of the optical disk such as CD or CD-RW. However, there are many variations on the construction of optical pickups and on the reflectance of the optical disk in general, so that it is preferable to set the gain such that the average value of the amplitudes of the focus error signal FE becomes a target value.

The gain of the variable gain amplifier 2 (multiplier 39a of FIG. 4) is set such that the average value of variations of the sensitivity of the drive circuit 14f and focus actuator FA becomes the target value 65b of FIG. 6B.

Next, the amplitude A of the focus error signal FE generated at the gain which has been set as the initial value is measured by the amplitude detector 41a. In the case of the amplitude of the focus error signal FE, as shown in FIG. 7A, a signal in which the drive voltage of the focus coil increases at a regular rate with respect to time axis is assumed. It is preferable to set the rate such that movement of 1.2 mm per second is obtained. The interlayer distance is set to about 50 μm in a dual-layer DVD disk and, accordingly, the time interval between waveforms L0 and L1 of FIG. 7B becomes about 40 msec. The amplitude detector 41a detects peak and bottom values d and e of the waveform L0 to obtain the amplitude A.

In the case of the amplitude of the tracking error signal TE, the control circuit 16 turns ON the switch 50 of the focus servo and then turns OFF of the tracking servo to obtain amplitude values a and b shown in FIG. 5C and, from the values a and b, obtains the amplitude value AT.

The control circuit 16 then compares the amplitude A measured in step S102 and previously set target amplitude value to calculate a difference B between respective amplitude values and stores the calculated difference B in an internal memory (not shown) (step S103). The gain of the variable gain amplifier 1 (multiplier 35a of FIG. 4) may be changed using the amplitude difference B so as to allow the error signal amplitude value to become a target value.

The control circuit 16 then turns ON the switch 50 of the focus servo (step S104). After that, the control circuit injects the disturbance signal OSC1 from the oscillator 37a to adder 36a to measure the loop gain D of the focus servo loop (step S105). That is, the control circuit 16 calculates a ration between the amplitude of the disturbance signal OSC1 input from the oscillator 37a to adder 36a and the amplitude of a signal input from the multiplier 35a to adder 36a to thereby measure the loop gain D of the focus servo loop.

Then, the control circuit 16 compares the measured loop gain D and a previously set target loop gain value to calculate a loop gain difference E and stores the loop gain difference E in an internal memory (not shown) (step S106). At the same time, the control circuit 16 sets a gain value corresponding to the loop gain difference E in the variable gain amplifier 2 (multiplier 39a of FIG. 4). The gain of the variable gain amplifier 2 (multiplier 39a of FIG. 4) may be changed using the amplitude difference E so as to allow the loop gain to become a target value.

Finally, the control circuit 16 calculates the sensitivity of the focus actuator FA based on the amplitude difference B obtained in step S103 or gain difference E obtained in step S106 (step S107).

Adjustment of a focus error signal in a dual-layer optical disk will next be described.

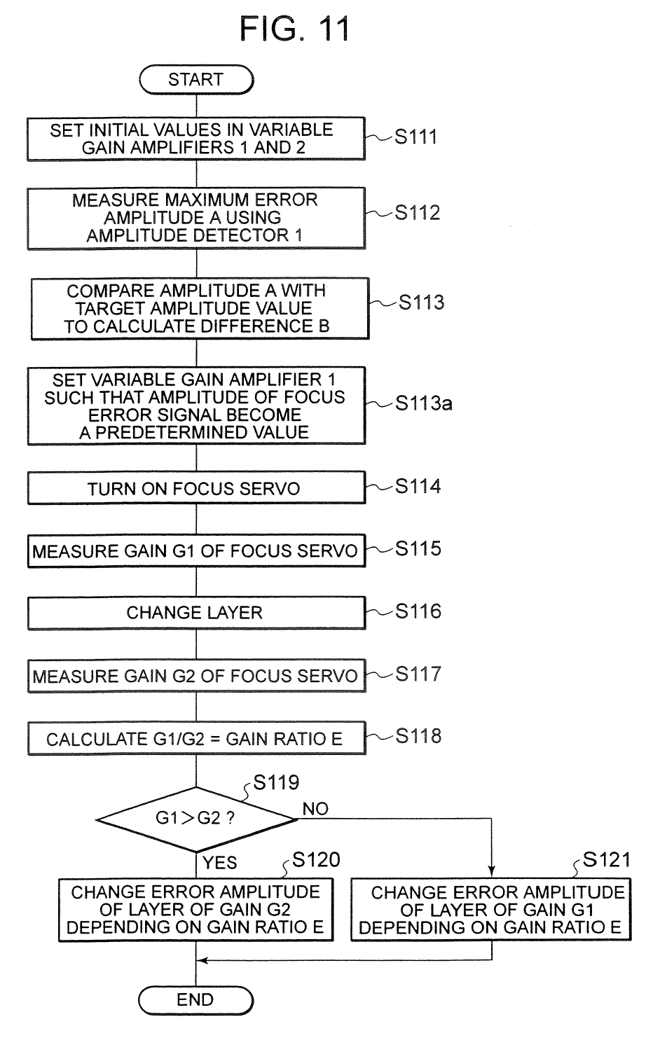

FIG. 11 is a flowchart showing operation of changing the amplitude of the focus error signal FE in the case where a dual-layer optical disk is used.

The control circuit 16 sets initial values in the variable gain amplifiers 1 and 2 (multipliers 35a and 39a of FIG. 4) (step S111). Then, the control circuit 16 uses the amplitude detector 41a to measure the amplitude value A of a focus error signal FA having the maximum error amplitude selected from among focus error signals FA reflected from respective layers of the optical disk (step S112). The control circuit 16 then compares the measured amplitude value A with a previously set target amplitude value to calculate a difference B between respective amplitude values (step S113). Based on the difference B, the control circuit 16 sets the variable gain amplifier 1 (multiplier 35a of FIG. 4) such that the amplitude of the focus error signal becomes a predetermined value (step S113a).

After the setting of the variable gain amplifier 1 (multiplier 35a of FIG. 4), the control circuit 16 turns ON the switch 50 of the focus servo (step S114). After that, the control circuit 16 measures a loop gain G1 of the focus servo loop in the first layer (layer 0) of the optical disk (step S115) in the same manner as described above. Then, the control circuit 16 changes a measurement target to the second layer (layer 1) of the optical disk (step S116) and measures a loop gain G2 of the focus servo loop in the second layer in the same manner as described above (step S117).

Then, the control circuit 16 calculates a gain ratio E between the loop gains G1 and G2 measured in the steps S115 and S117 (step S118). If the loop gain G1 is larger than the loop gain G2 (Yes in step S119), the control circuit 16 changes the gain of the variable gain amplifier 2 (multiplier 39a of FIG. 4) such that the amplitude of the error signal of the second layer (layer 1) increases depending on the gain ratio E (step S120).

On the other hand, if the loop gain GC is smaller than the loop gain G2 (No in step S119) the control circuit 16 changes the gain of the variable gain amplifier 2 (multiplier 39a of FIG. 4) such that the amplitude of the error signal of the first layer (layer 0) decreases depending on the gain ratio E (step S121). Therefore, by executing step S120 or step S121, it is possible to set the gain of the variable gain amplifier 2 (multiplier 39a of FIG. 4) such that the error signal amplitudes in respective layers are made equal to each other and are made corresponding to a target amplitude value.

As described above, the control circuit 16 measures the loop gain G1 of the focus servo loop in the first layer of the optical disk, in which the maximum error amplitude value of the focus error signal FE is measured as well as measures the loop gain G2 of the focus servo loop in the second layer, so that it is possible to easily estimate the amplitude value of the focus error signal in the second layer based on the above measurement results (e.g., gain ratio E).

Additional measurement may be performed for confirmation after the gain of the variable gain amplifier 2 is adjusted based on the estimated focus error amplitude value such that the signals from the respective layers become constant. In this case, it is possible to increase accuracy. As a matter of course, reproduction operation may be performed immediately after the adjustment. In this case, it is possible to reduce the measurement time, resulting in a reduction of time that elapses before reproduction. Further, the focus error amplitude value that has been estimated based on the information of reflected signals can be used in the focus servo and tracking servo.

A circuit for estimating the focus error amplitude value from the signals reflected from the respective layers and a circuit for performing adjustment based on the focus error amplitude value such that the signals from the respective layers become constant are included in the control circuit 16.

There is about a 3-fold difference in reflectance between DVD-R and DVD-RW. Further, there is a 1.5-fold difference in reflectance between respective layers in some optical disks including a plurality of layers. There is a case where reflected signals from such an optical disk are subjected to arithmetic processing to perform focus error or tracking error calculation/detection, ATIP calculation/detection, LPP signal calculation/detection, total-reflected level calculation/detection. In the case where the above detections/calculations are performed, it is necessary to process especially analog calculation or A/D converter with a limited dynamic range.

Therefore, the gain is changed by knowing the amplitude values of the focus error signals FE of respective layers previously, a head amplifier gain is increased when a signal level is low, and a head amplifier gain is decreased when a signal level is high. Further, to make it easy to reliably detect the focus error signal within a dynamic range is useful for ensuring detection accuracy. According to the present invention, it is possible to detect and provide information corresponding to the reflectance of the respective layers at the earliest possible stage.

Assume that the reflectance of the first layer is 10% and that of the second layer is 5%. In this case, if the gain at the time of reproduction from the first layer is set to, e.g., 0 dB and the gain at the reproduction from the second layer is set to, e.g., 6 dB, it is possible to perform detection processing at the same level. The reflectance appears in the output of the photodetector, so that the focus error signal or total-reflected signal can be used.

The total reflected signal is obtained from addition; whereas the focus error signal is obtained from subtraction. Therefore, the focus error signal is more advantageous in terms of noise. The tracking error signal is obtained from subtraction and thus can be used. However, it is adversely affected by the track pitch and is inferior to the focus error signal in terms of accuracy of reflection information.

If the reflectance can be estimated from the loop gain of the focus servo loop, a difference in reflectance between respective layers becomes clear before turning ON of the tracking servo, resulting in an increase of accuracy at the tracking servo ON time.

The present invention is not limited to the above embodiment and various modifications may be made within the technical scope of the present invention.

What is claimed is:

1. An optical disk apparatus comprising:
a focus error signal generation unit which generates a focus error signal for detecting a focal point of a beam spot based on a signal that has been read out from an optical disk through an optical pickup;
a focus gain detection unit which detects the loop gain of a focus servo loop based on the focus error signal output from the focus error signal generation unit; and
a drive unit which drives a focus actuator for moving the optical pickup in the focusing direction by a drive signal that has been gain adjusted depending on the loop gain detected by the focus gain detection unit at layer jump time.

2. The optical disk apparatus according to claim 1, wherein
the moving speed of the optical pickup is corrected by the gain adjustment.

3. The optical disk apparatus according to claim 1, further comprising an adjustment unit of focus error signal amplitude which adjusts the amplitudes of focus error signals so as to make them equal to each other depending on a plurality of loop gains of a focus servo loop obtained from respective layers of an optical disk including a plurality of layers.

4. The optical disk apparatus according to claim 1, wherein
the drive unit adjusts an acceleration pulse or deceleration pulse to be supplied to the focus actuator depending on the loop gain of a focus servo loop.

5. The optical disk apparatus according to claim 1, further comprising a variable gain unit which is provided at the front stage of the drive unit driving the focus actuator and which changes the gain of the drive unit depending on the loop gain of a focus servo loop.

6. The optical disk apparatus according to claim 5, wherein
the variable gain unit adjusts a differential gain or reference speed depending on the loop gain of a focus servo loop.

7. An optical disk apparatus comprising:
a tracking error signal generation unit which generates a tracking error signal of a beam spot based on a signal that has been read out from an optical disk through an optical pickup;
a tracking gain detection unit which detects the loop gain of a tracking servo loop of the tracking error signal that has been out from the tracking error signal generation unit; and
a drive unit which drives a tracking actuator for moving the optical pickup in the tracking direction by a drive signal that has been gain adjusted depending on the loop gain detected by the tracking gain detection unit.

8. The optical disk apparatus according to claim 7, wherein
the moving speed of the optical pickup is corrected by the gain adjustment.

9. The optical disk apparatus according to claim 7, further comprising a variable gain unit which is provided at the front stage of the drive unit driving the tracking actuator and which changes the gain of the drive unit depending on the loop gain of a tracking servo loop.

10. The optical disk apparatus according to claim 7, wherein
the drive unit adjusts an acceleration pulse or deceleration pulse to be supplied to the tracking actuator depending on the loop gain of a tracking servo loop.

11. An optical disk apparatus comprising:
a focus error signal generation unit which generates a focus error signal for detecting a focal point of a beam spot that irradiates an optical disk including at least first and second layers with a laser beam based on a signal that has been read out from the optical disk through an optical pickup;
a focus gain detection unit which detects the loop gain of a focus servo loop of the focus error signal output from the focus error signal generation unit; and
an amplitude measurement unit which performs focus search based on the focus error signal and measures the amplitude of the focus error signal at the time of the focus search, wherein
a first loop gain in the first layer representing the maximum error amplitude measured by the amplitude measurement unit and a second loop gain in the second layer are compared with each other to estimate the amplitude width of the focus error signal in the second layer.

12. The optical disk apparatus according to claim 11, wherein
a gain of a variable gain unit on the output side is adjusted based on the estimated amplitude value of the focus error signal such that the amplitudes of the focus error signals from the first and second layers become constant.

13. A signal processing method of an optical disk apparatus, comprising the steps of:
measuring the amplitude of a focus error signal at a gain set as an initial value;
comparing the measured amplitude and a previously set target amplitude value to calculate a difference between the amplitudes;
measuring the loop gain of a focus servo loop at the time when a disturbance signal is injected in a state where a focus servo loop is ON;
comparing the measured loop gain and a previously set target loop gain to calculate a difference between the loop gains;
calculating the sensitivity of a focus actuator based on the amplitude difference or loop gain difference; and
driving the focus actuator by the loop gain of a focus servo loop corresponding to the calculated sensitivity.

14. A signal processing method of an optical disk apparatus, comprising the steps of:
generating a focus error signal for detecting a focal point of a beam spot that irradiates an optical disk including at least first and second layers with a laser beam based on a signal that has been read out from the optical disk through an optical pickup;
performing focus search based on the focus error signal to measure the amplitude of the focus error signal at the time of the focus search; and
comparing a first loop gain in the first layer representing the measured maximum error amplitude and a second loop gain in the second layer with each other to estimate the amplitude width of the focus error signal in the second layer.

15. The signal processing method of an optical disk apparatus according to claim 14, wherein
the gain of a variable gain unit on the output side is adjusted based on the estimated amplitude value of the focus error signal such that the amplitudes of the signals from the first and second layers become constant.
